(19) United States
(12) Patent Application Publication
(10) Pub. No.: US 2024/0324091 A1
(43) Pub. Date: Sep. 26, 2024

(54) PLASMA TORCH AND METHOD OF OPERATION

(71) Applicant: HIIROC-X DEVELOPMENTS LIMITED, Tunbridge Wells (GB)

(72) Inventor: Ate WIEKAMP, Tunbridge Wells (GB)

(21) Appl. No.: 18/555,001

(22) PCT Filed: Apr. 13, 2022
(86) PCT No.: PCT/GB2022/050935

§ 371 Date: Oct. 12, 2023

(30) Foreign Application Priority Data
Apr. 13, 2021 (GB) 2105248.5

(51) Int. Cl. H05H 1/34; H05H 1/42

(52) U.S. Cl. CPC H05H 1/3405; H05H 1/3436; H05H 1/42; H05H 1/3468; H05H 2245/10

(57) ABSTRACT

A plasma torch for use in a chemical reactor is described. The plasma torch has a torch chamber with an open end for outflow of reaction products and a closed end opposite to the open end. A first and a second electrode are disposed in the torch chamber, with the second electrode between the first electrode and the open end. An input system is provided for input of one or more gaseous feedstocks into the plasma torch. The plasma torch is adapted to operate at substantially above atmospheric pressure. The plasma torch is also configured so that flow of gaseous feedstocks and reaction products through the torch is adapted to prevent or reduce solid deposition on the second electrode. A suitable method of operating a plasma torch in a chemical reactor is also described.

### FIELD OF INVENTION

The present invention relates to a plasma torch and a method of operation for a plasma torch. It is particularly relevant for a plasma torch for use in a chemical reactor.

### BACKGROUND OF INVENTION

A plasma torch is a device that produces a flow of plasma from a feedstock gas by action of an electric arc between electrodes. Typically, this is a directed flow of plasma, and plasma torches are used for a variety of purposes including cutting, welding, and gasification of waste.

One particular field of use for plasma torches, or plasma burners, is in reactors for high temperature decomposition. One process using such plasma burners is the Kvaerner process for decomposition of hydrocarbons to form carbon black and hydrogen. This is an endothermic reaction taking place in a plasma burner at about 1600 degrees Centigrade. The Kvaerner process reaction is as follows:

$${C}_{n} {H}_{m} \to nC + \frac{m}{2} {H}_{2}$$

Unlike most methods for formation of hydrogen from hydrocarbons, carbon dioxide is not a by-product, so this can be a particularly clean method for forming useful products from hydrocarbons such as methane, which is largely treated as a polluting waste gas. It would be desirable to be able to develop plasma torches that were particularly suitable for use in reactions such as the Kvaerner reaction.

### SUMMARY OF INVENTION

In a first aspect, the invention provides a plasma torch for use in a chemical reactor, the plasma torch comprising: a torch chamber with an open end for outflow of reaction products and a closed end opposite to the open end; a first electrode disposed in the torch chamber; a second electrode disposed in the torch chamber between the first electrode and the open end; an input system for input of one or more gaseous feedstocks into the plasma torch; wherein the plasma torch is adapted to operate at substantially above atmospheric pressure and wherein the plasma torch is configured so that flow of gaseous feedstocks and reaction products through the torch is adapted to prevent or reduce solid deposition on the second electrode.

Using this approach, the plasma torch is effective to process feedstock gases without significant deposition occurring within the plasma torch itself. This allows the plasma torch to be used for longer periods of time without being taken out of service, and so enables the reactor to operate continuously for longer periods.

In embodiments, at least the second electrode is substantially cylindrical. This second electrode may have a circular cross section, but such that the cross-sectional diameter varies along the length of the second electrode. In particular embodiments, the second electrode may comprise a Venturi nozzle and a diffuser section at the open end to collimate an outflow of reaction products. This approach keeps the reaction products away from the walls of the plasma chamber, preventing deposition, and accelerates and directs them so that the plasma torch provides an output jet of reaction products. As will be noted below, this may be used very effectively in overall reactor design.

The closed end may in embodiments be formed by a ceramic cup. A section of the torch chamber comprising one or more gas inputs from the input system may have a generally circular cross-section. The one or more gas inputs may be directed tangentially to the circular cross-section of the torch chamber. These one or more gas inputs may be disposed in a ceramic ring element of which an inner surface forms a part of a wall of the torch chamber. There may be a plurality of gas inputs in this ceramic ring element, the gas inputs being disposed symmetrically around the inner surface of the ceramic ring element.

Using this approach to providing gas inputs, the torch chamber may be shaped to support a helical flow of gases through the torch chamber. Such a helical flow of gas through the torch chamber may involve a double-helix structure—a larger diameter helix from the gas inlet or inlets to the closed end of the torch chamber, and a smaller diameter helix from the closed end of the torch chamber to the open end of the torch chamber. This approach has multiple benefits. First of all, the reaction of feedstock gases with the plasma spark will occur primarily in the inner helix, and output products will be produced primarily in the inner helix and then transported rapidly through the open end of the plasma torch. Secondly, the electrodes will generally see a lower temperature than the reaction temperature as they are adjacent to the feedstock gases before reaction, rather than the reaction products superheated by the plasma spark. This will enhance electrode life and hence plasma torch life.

In embodiments, there may be one or more intermediate electrodes disposed between the first electrode and the second electrode. Such intermediate electrodes may be substantially cylindrical.

In embodiments, either or both of the first and second electrodes may be porous, and each such porous electrode may be connected to a gas input to allow gas to flow through the electrode. Using this approach, a gas input at a cooler temperature can be used to cool the electrodes directly, again prolonging electrode life. The passage of such gas through the electrode may have a component either towards or away from the open end of the torch chamber. In this way, the gas can operate as a protective curtain for the electrode, and it can cooperate with a helical flow regime for feedstock gases and reaction products through the plasma torch.

As noted, such a plasma torch may be adapted to operate at an internal pressure substantially above atmospheric pressure—while there are benefits even in lower pressures (such as 10 barg or 30 barg) using this approach, operation at around 50 barg (for example, within a working range of 40 to 60 barg) is practical to achieve and will provide a high reaction throughput.

The plasma torch may be adapted for the gaseous feedstock to comprise at least one hydrocarbon and for the reaction products to comprise hydrogen. The plasma torch may then operate to decompose hydrocarbons into constituent elements—in such a case, the solid deposition may be deposition of carbon. With this approach, the gaseous feedstock further may further comprise hydrogen as the gas input to each porous electrode. In this way, the outputs from the plasma torch would comprise hydrogen and carbon, with the hydrogen comprising primarily reaction product along with some gas input to cool the electrodes.

In embodiments, the plasma torch is adapted to jet into a non-reactive liquid, such as a liquid metal. The diffuser may then be adapted to provide a collimated jet of the reaction product outflow into the non-reactive liquid. In embodiments, when the plasma torch is turned off, non-reactive liquid enters and partially fills the plasma torch chamber. This can be used to clean the plasma torch chamber, to regenerate electrodes (for a liquid metal), and to provide a soft start for the plasma torch without erosion by an initial spark as the effect of an initial voltage pulse can be absorbed by a plug which is heated and expelled on startup (for a liquid metal, or other conductive material, which is liquid at reaction temperature but solid at ambient temperature).

In a second aspect, the invention provides a method of operating a plasma torch in a chemical reactor, the plasma torch comprising a torch chamber with an open end for outflow of reaction products and a closed end opposite to the open end, with a first electrode disposed in the torch chamber and a second electrode disposed in the torch chamber between the cathode and the open end, the plasma torch further comprising an input system for input of feedstock gases into the plasma torch, the method comprising: flowing one or more feedstock gases into the torch chamber through the input system; consuming one or more feedstock gases in the plasma torch to form one or more reaction products; and operating a flow of feedstock gases and reaction products through the plasma torch so as to prevent or reduce solid deposition on the second electrode, wherein the pressure in the plasma torch is substantially above atmospheric pressure.

In such a method, solid deposition may be reduced by accelerating flow through the second electrode by use of a Venturi nozzle. In embodiments, a wall of the torch chamber is substantially circular in cross-section where feedstock gases are injected into the torch chamber, and solid deposition is reduced by injecting feedstock gases into the torch chamber tangentially to the circular cross-section of the torch chamber wall such that the feedstock gases adopt a helical path through the torch chamber. Such a helical path may comprise a larger diameter helix from the input of gases into the torch chamber to the closed end of the chamber, and a smaller diameter helix from the closed end of the chamber to the open end of the chamber, thereby keeping a flow of reaction products away from the wall of the torch chamber. The first electrode and the second electrode may be configured such that a spark gap therebetween is adapted to pass primarily through the smaller diameter helix.

As noted, such a plasma torch may be adapted to operate at an internal pressure substantially above atmospheric pressure—while there are benefits even in lower pressures (such as 10 barg or 30 barg) using this approach, operation at around 50 barg (for example, within a working range of 40 to 60 barg) is practical to achieve and will provide a high reaction throughput.

In embodiments, the first electrode and the second electrode may be disposed such that sparking between the first electrode and the second electrode is adapted to erode any solid deposition on the second electrode.

In embodiments, one or both of the first electrode and the second electrode may be porous, and input gas can be flowed through each such porous electrode, and over a surface of each such porous electrode, so the surface of each such electrode is protected from solid deposition. Flowing input gas through each such porous electrode in this way may erode solid deposition by a reaction with deposited solid material. Preferably, the input gas flowing through the or each porous electrode has a component of flow in the direction of either towards or away from the open end of the torch chamber. The input gas flowing through the or each porous electrode may be substantially cooler than the feedstock gas or reaction products, and so the input gas may be adapted to cool the porous electrode.

A flow of reaction products out of the plasma torch may be provided directed as a jet into a stream of non-reactive liquid, such as a liquid metal. When the plasma torch is turned off, non-reactive liquid may then enter and partially fill the plasma torch chamber. In operation, such a flow of reaction products may provide heat and momentum to the stream of non-reactive liquid. The non-reactive liquid may comprise a liquid metal, liquid metal alloy, or liquid salt. In particular embodiments, the non-reactive liquid is a liquid at a reaction temperature and a solid at ambient temperature—if the non-reactive liquid is also conductive, this has particular benefits for torch ignition. Where a liquid metal alloy is used, this may comprise lead or bismuth. The feedstock gases may comprise methane, or another suitable hydrocarbon. The feedstock gases may also then comprise hydrogen, and said hydrogen is used as the input gas for the porous electrode or electrodes.

### BRIEF DESCRIPTION OF FIGURES

Embodiments of the invention will now be described, by way of example, with reference to the accompanying Figures, of which:

FIG. 1 shows a side elevation view of a reactor according to an embodiment of the invention;

FIG. 2 shows a high-level schematic diagram of the main functional elements of a reactor according to an embodiment of the invention;

FIG. 3 shows a longitudinal cross-section of a plasma torch from a reactor according to an embodiment of the invention;

FIG. 4 show a detail from the plasma torch of FIG. 3 showing additional elements of the anode, and illustrating features that prevent carbon build-up;

FIG. 5 shows flow of reaction gases through the plasma torch of FIG. 3;

FIGS. 6A and 6B show side elevation and sectional views respectively of a ring for inlet of feedstock gases for use in the plasma torch of FIG. 3;

FIG. 7 shows a revolver system comprising a set of plasma torches and a feedstock system according to an embodiment of the invention;

FIG. 8 shows a plasma torch in the process of removal from the revolver system of FIG. 7;

FIGS. 9A and 9B shows a gearing system for rotation of the revolver system of FIG. 7;

FIG. 10 shows a feedstock system for use in the revolver of FIG. 7;

FIG. 11 illustrates an exemplary reaction process for a reactor system according to an embodiment of the invention;

FIG. 12 illustrates a liquid metal pyrolysis reactor system driven by the plasma torch system of FIGS. 3 to 11 and including a housing for the plasma torch system;

FIGS. 13A and 13B illustrate the liquid metal circulation system of the reactor of FIG. 12 driven by the plasma torch;

FIGS. 14A and 14B provide different sectional views of the liquid metal circulation system of FIGS. 13A and 13B;

FIG. 15 illustrates the liquid metal pyrolysis reactor of FIG. 12 in more detail;

FIG. 16 illustrates feed systems to the liquid metal pyrolysis reactor of FIG. 15, together with a carbon output;

FIG. 17 shows feed systems in a swirl chamber of the liquid metal pyrolysis reactor of FIG. 16;

FIG. 18 shows a vertical section through a part of the liquid metal pyrolysis reactor of FIG. 15;

FIG. 19 shows a modified reaction flow for syngas generation;

FIGS. 20a and 20b show different views of a second embodiment of a plasma torch for use in embodiments of the invention;

FIGS. 21a and 21b show different views of a third embodiment of a plasma torch for use in embodiments of the invention; and

FIG. 22 is a system diagram of a reactor system according to a further embodiment of the invention.

### DESCRIPTION OF SPECIFIC EMBODIMENTS

General and specific embodiments of the invention will be described below with reference to the Figures.

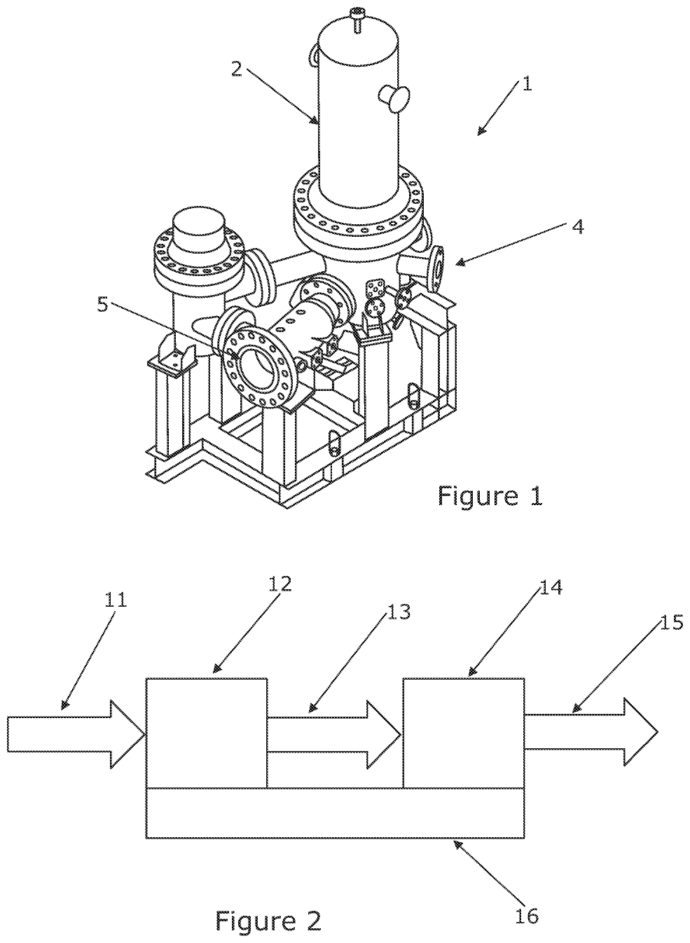

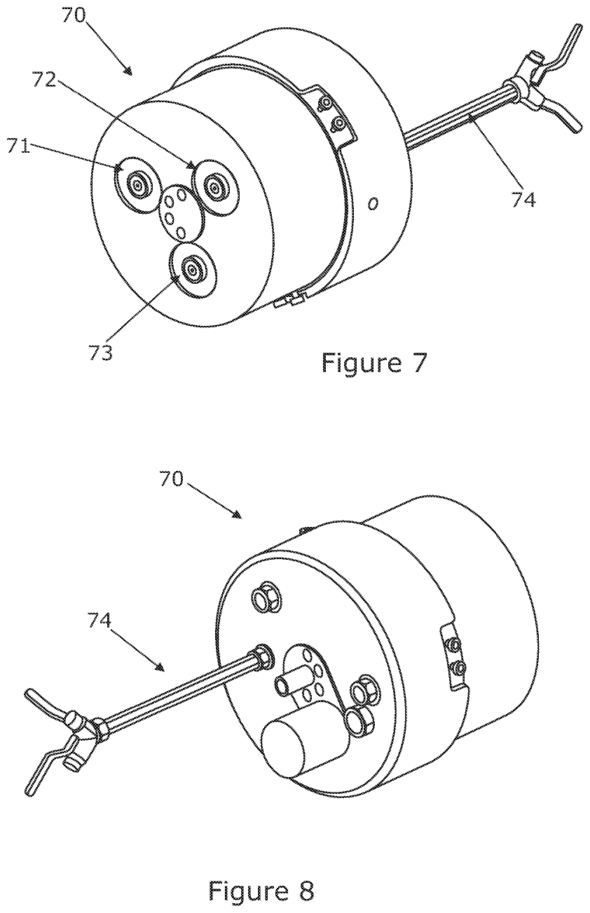

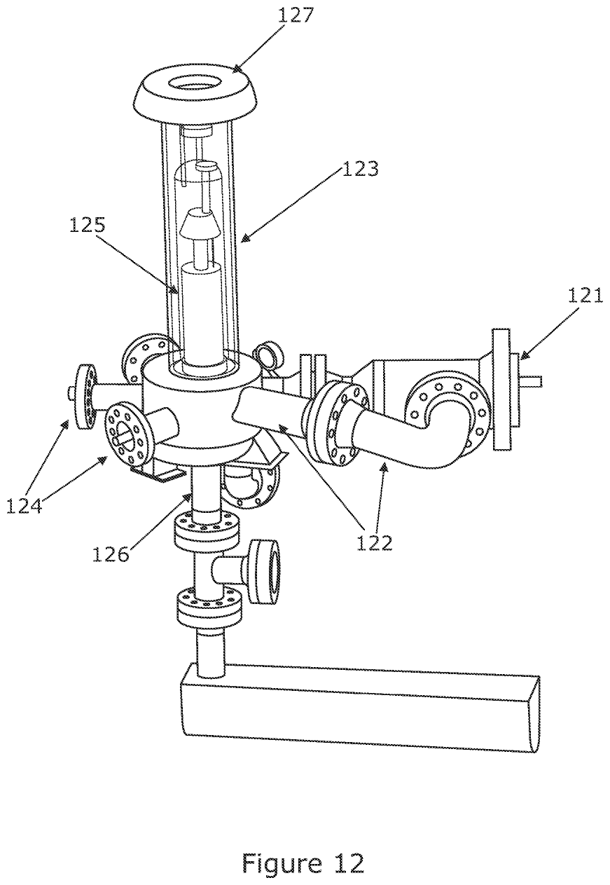

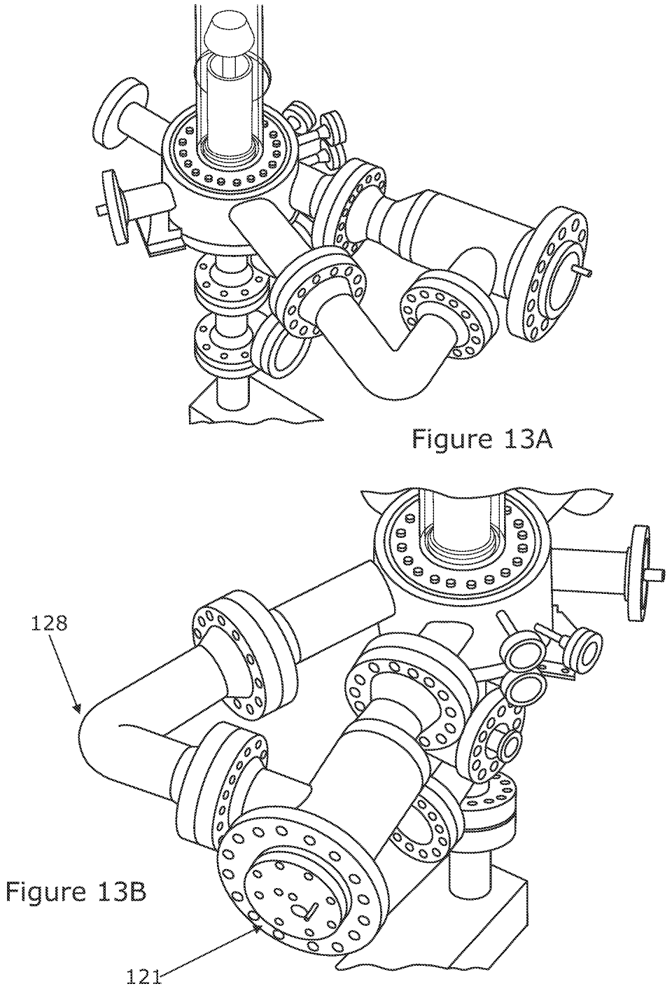

FIG. 1 provides a perspective view of a reactor according to an embodiment of the invention. The reactor 1 is formed as a pressure vessel 2 with electrical inputs to power a plasma torch (not shown here, though FIG. 12 shows how this is integrated into the system) and gas inputs 4 for gaseous feedstocks to be admitted to the system. These inputs are each directed to a revolver assembly (not shown here, see FIGS. 7 to 9 and 12 for further details) adapted to fit into an assembly aperture 5—the revolver assembly houses a set of plasma torches and which also provides gaseous feedstock to each plasma torch. The reactor shown here has multiple stages—the plasma torches act as a first reactor stage, with a liquid metal reactor as a further reactor stage consuming heat generated by the plasma torches. The reaction products include heated gas—hydrogen in the main example discussed below—and a heat exchanger uses the heated gas to bring feedstock gases to the correct temperature for reaction, effectively acting as a preliminary reactor stage.

The reactor system is shown schematically in FIG. 2. Gaseous inputs 11—for example, hydrocarbons such as methane, and additional hydrogen for cooling (though this may be recirculated from the output products)—are admitted into the plasma torch 12, and the plasma torch 12 consumes the input feedstock gases providing a first set of output products, such as carbon and hydrogen. These first output products pass at high temperature as inputs 13 into a liquid metal system 14, which then in embodiments provides pyrolysis of further feedstock gas. Final output products 15—such as carbon, which may depending on the design be extracted through the liquid metal or from the gaseous output, and hydrogen, output as a gas—are provided from liquid metal reactor 14 after a separation process—these final output products include the first output products from the plasma torch 12 and may be supplemented by further output products produced from pyrolysis in the liquid metal reactor 14. The pyrolysis reaction is endothermic, but there is still sufficient heat present that the gaseous final output products are at significantly greater temperature than desired for storage, so there is excess heat to be used. Here, this heated gas output issued by a heat exchanger 16 which controls the temperature of feedstock gases for different stages of the reactor process. As will be noted further below, embodiments of the invention may not require all the features shown in the FIG. 2 arrangement to operate—the FIG. 2 arrangement is a synergistic combination of a series of processes for particularly effective production of carbon and hydrogen from hydrocarbons such as methane. As will be indicated further below, such processes may also be adapted to produce other output products, such as syngas.

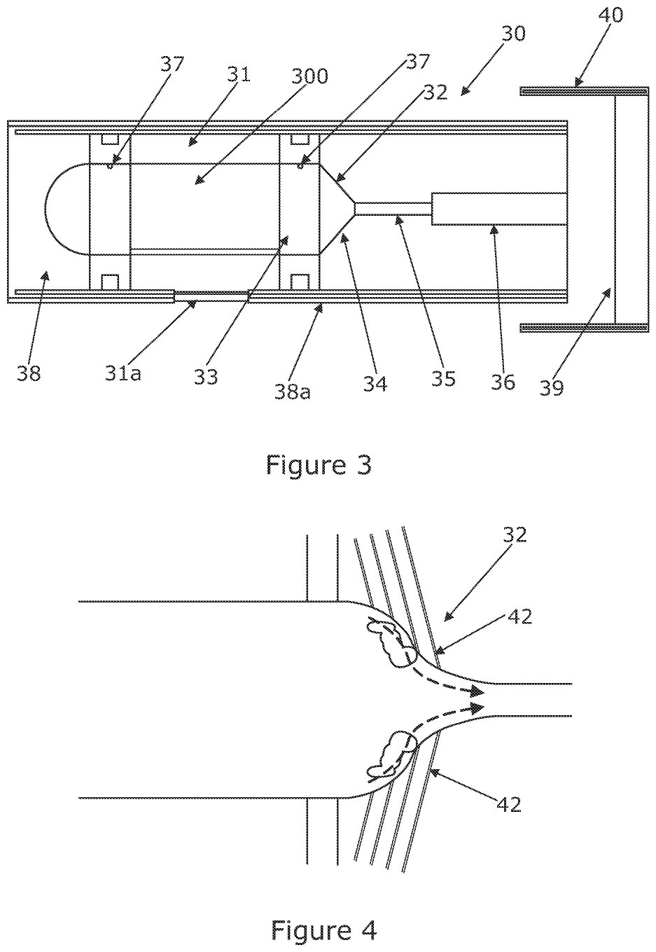

An embodiment of the plasma torch is shown in more detail in FIGS. 3 to 5. A longitudinal sectional view of the plasma torch 30 is provided in FIG. 3. The plasma torch 30 is generally cylindrical, and in the arrangement used in embodiments of the invention, it extends into a liquid metal circulation system 40 (discussed further below) where it jets directly into the liquid metal. The plasma torch has a central chamber 300 containing a cathode 31 and an anode 32. These may be of any conductive material suitable for the conditions in the central chamber 300—carbon (graphite) could be used, or any suitable metal or alloy, either uniform or with suitable inserts—for example, copper with hafnium inserts would be a possible choice. Here, the cathode 31 is located towards the end of the plasma torch 30 remote from the liquid metal reactor 39, with a ceramic cup-shaped end section 38 terminating the plasma torch. In alternative torch designs, the electrodes may be disposed the other way around, or an alternating current plasma torch may be used in which it is only meaningful to talk of electrodes, rather than anode and cathode. The anode is generally cylindrical, but it has a shaped inner surface 34 which comprises a nozzle 35 and a diffusing section 36, which will be described in greater detail below. A protective electrode 33 may be disposed between the cathode 31 and the anode 32—the skilled person will appreciate that again the electrode structure may be varied to achieve a desired field pattern within the plasma torch chamber, and may involve none, one or multiple intermediate electrodes—multiple protective electrodes may be cascaded to help stabilisation of the spark, for effective ignition, or to prevent wear on the anode. Gas inputs 37 are provided to admit gaseous feedstock into the reactor—in the arrangement shown in FIG. 3, methane is admitted in the gas input 37 disposed in the protective electrode 33. As will be indicated in further detail below, different gas input positions are provided for different feedstock gases in different embodiments of the invention. While the discussion below will refer primarily to methane, it should be appreciated that other hydrocarbons may equally well be used—for example, propane can be transported in liquid form but will vaporise easily for reaction in a plasma torch reactor, so will be another particularly suitable choice for processing.

FIG. 4 illustrates one phenomenon in the use of the plasma torch 30 shown in FIG. 3 to break down methane. In this reaction, methane decomposes at high temperature into hydrogen gas and carbon through action of the plasma torch spark, which may have a temperature of 6000 degrees Centigrade, resulting in instant decomposition. A practical issue is that this may result in carbon deposits 41 which would clog the torch, which will significantly affect the efficiency of the process and which could lead to significant downtime for maintenance. It would be desirable to prevent such carbon build up, and for both reaction products to exit the plasma torch 30. One feature to achieve this is to protect the anode with a gas that will inhibit build up. This can be achieved by making the anode 32 porous, with anode gas outputs 42 delivering gas—in this case, hydrogen, through the anode to provide a protective curtain along the inside of the anode, inhibiting carbon build up. The gas is delivered at an angle to the anode such that it has a component of velocity towards the plasma torch output to achieve this protective curtain—alternatively, a component of velocity can be provided away from the plasma torch output, as this will still provide a protective curtain to the electrode. In addition to providing a protective curtain, there may also be active erosion of deposited carbon by the hydrogen—the hydrogen can react with the carbon in a back reaction back to methane, thus further eroding any carbon deposited. The hydrogen also serves to cool the anode, preventing it from being degraded. In addition to using a porous anode in this way, the cathode can also be made porous and cooled in a similar way.

Further strategies are used to prevent carbon build-up. The shaping of the anode can also be arranged such that a likely deposition point for carbon would be on the anode in the region of the spark gap with the torch in operation—spark action can then further erode any carbon build-up.

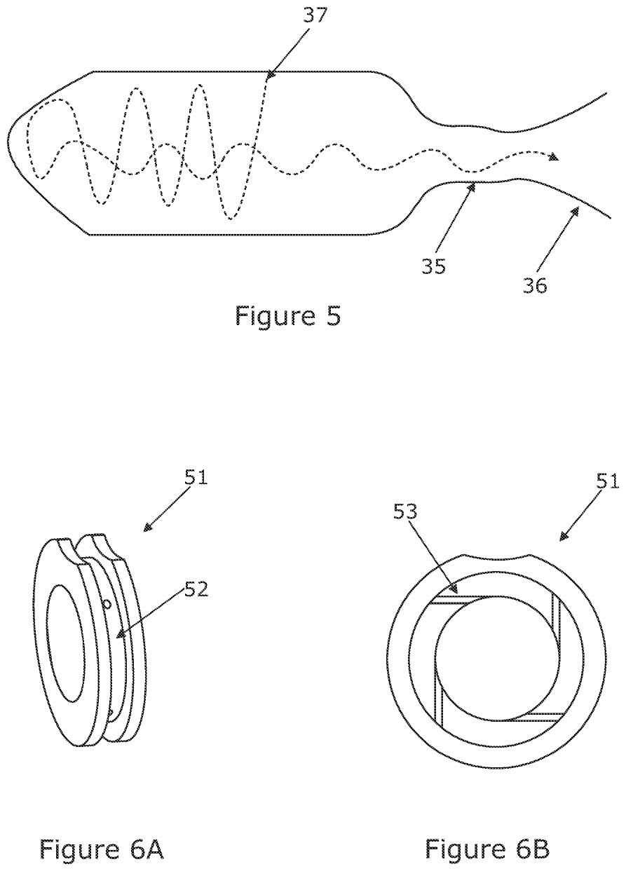

Another feature that prevents carbon build up is shown in FIG. 5, which illustrates the passage of gas through the plasma torch structure. Here, methane enters the plasma torch tangentially through the gas input 37 in the protective electrode, and this input methane travels towards the cathode following a generally helical path. The gas input 37 here is provided through a ceramic ring 51, shown in more detail in FIGS. 6a and 6b. The ceramic ring 51 has a gallery 52 for circulation of the input gas around the ring, allowing the input gas to pass into a number (four in the design shown) of channels 53 which deliver input gas tangentially into the chamber, establishing both a helical path in the output gas adjacent to the wall of the chamber and also a vortex within the plasma torch chamber. This may be optimised taking into account gas type, flow conditions, pressure and temperature to achieve the desired flow pattern. The wall structure (in particular wall roughness and geometry promotes the outer helix of gas maintaining its momentum and separating from the faster rotating inner helix of gas, with the torch geometry forcing the gas into an inner returning helix at a greater speed and with a tighter inner circle. The gas adopts this tighter helix on travelling back between cathode and anode, and it maintains this on heating as it is broken down into carbon and hydrogen in the spark gap between the cathode and the anode. Plasma formation is rapid—it will typically take less than a microsecond. For a gas, proper tuning allows this to be tuned (by pressure, temperature and density) to minimise exchange of energy between the helices, similarly to a tornado. This configuration already gives the output gas—in this case, hydrogen—significant velocity towards the output of the plasma torch, and it will also prevent carbon condensation and deposition, as the carbon is formed in the centre of the plasma torch chamber rather than at the walls. The plasma comprises ions and electrons in energetic balance in a state of near thermal equilibrium, with molecules largely decomposed into atoms—under operating conditions of temperature and pressure in the plasma torch, the stable state of carbon is as a gas, reducing likelihood of carbon deposition. The plasma torch design is generally arranged so as to promote the reaction in the centre of the chamber and to inhibit it at the walls, so that the reaction products are preferentially driven out of the plasma torch into the liquid metal reactor. The outer helix cools and insulates the wall, while preventing atomic carbon in the inner helix from condensing on the walls. The hydrogen from the reaction passes through the nozzle 35, which results in an increase in speed and a decrease of pressure according to the Venturi effect. The gas is then output from the plasma torch 30 through the diffuser 36 with high temperature (and kinetic energy)—the plasma is ejected from the torch at supersonic speeds. By the cumulative effect of these features, carbon is generally carried through into the plasma torch output without significant build-up of deposit on the walls of the anode. The role of the diffuser 36 is to match the pressure of the output of the plasma torch with the next reactor stage, as will be described in more detail below. As noted here, the embodiment described in detail here, the next reactor stage is a liquid metal reactor—the liquid metal here may also be used to interact directly with the torch, as will also be discussed further below.

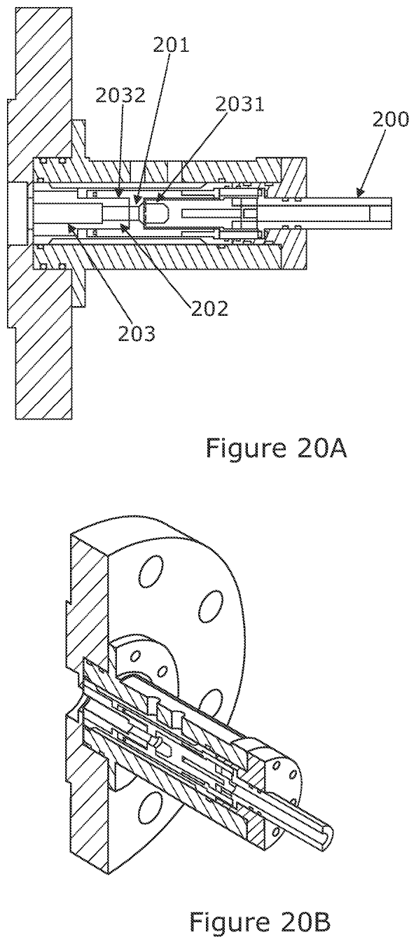

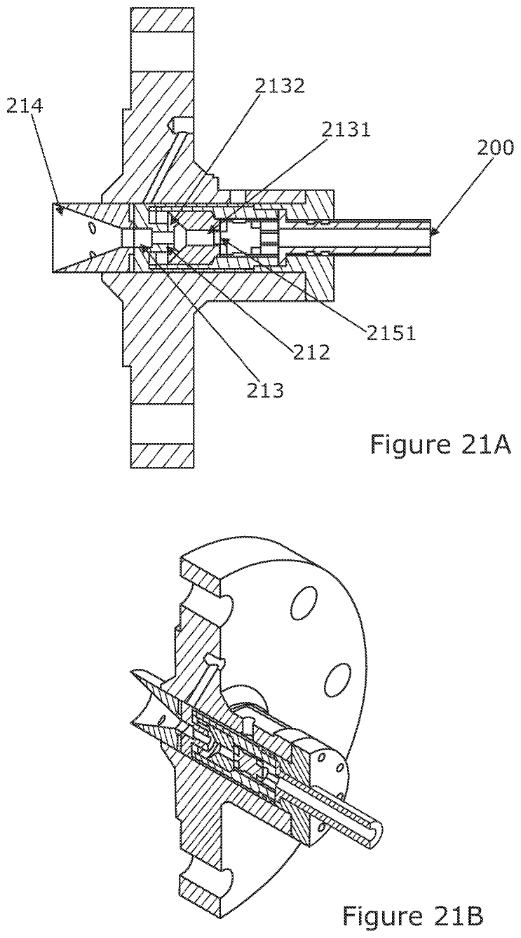

Alternative plasma torch designs for use in embodiments of the invention are shown in FIGS. 20a and 20b (for a second torch embodiment) and FIGS. 21a and 21b (for a third torch embodiment). FIGS. 20a and 20b show a plasma torch with a gas input line 200 located in line with the torch chamber, but with the cathode 2031 and the anode 2032 separated by a spacer 201—the cathode 2031 here forms the cup end, with a smaller diameter passage region 202 being formed through the anode opening out into a larger diameter passage region 203 for the plasma torch output. FIGS. 21a and 21b show an alternative embodiment with a swirl plate 2151 providing gas entry into the chamber at the closed end adjacent to a cathode 2131 (here made of Molybdenum) in tubular form. The anode 2132 is stepped as before with a smaller diameter passage region 212 and a larger diameter passage region 213, but in this case these regions are shorter relative to the plasma chamber and the larger diameter passage region 213 terminates in a diffuser 214 of linearly increasing diameter.

This arrangement in the torches described above allows for operation at high temperature (above 6000 degrees Centigrade at the point of reaction) and hyperbaric pressure in the torch, with a very high throughput of gaseous feedstock. For an input of 200 kW of power into the plasma torch, and with operating temperatures within the torch chamber in the region of 6000 degrees Centigrade at the point of reaction and pressures of 50 bar, approximately 72 kg/hour of methane can be processed using this design. The voltage across the electrodes will typically be between 150V and 600V, typically about 250V, with operating current between 100 A and 500 A, typically about 200 A. Feedstock gases can be pre-heated by using a heat exchanger—taking advantage of the heat given out in the pyrolysis reaction (see further discussion below), though hydrogen used to cool the anode will be provided at a lower temperature.

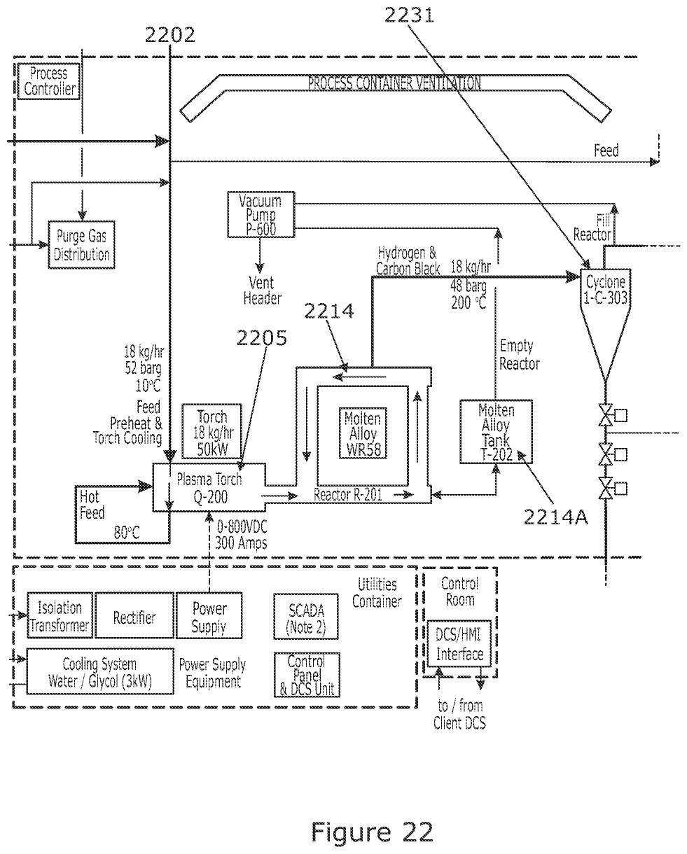

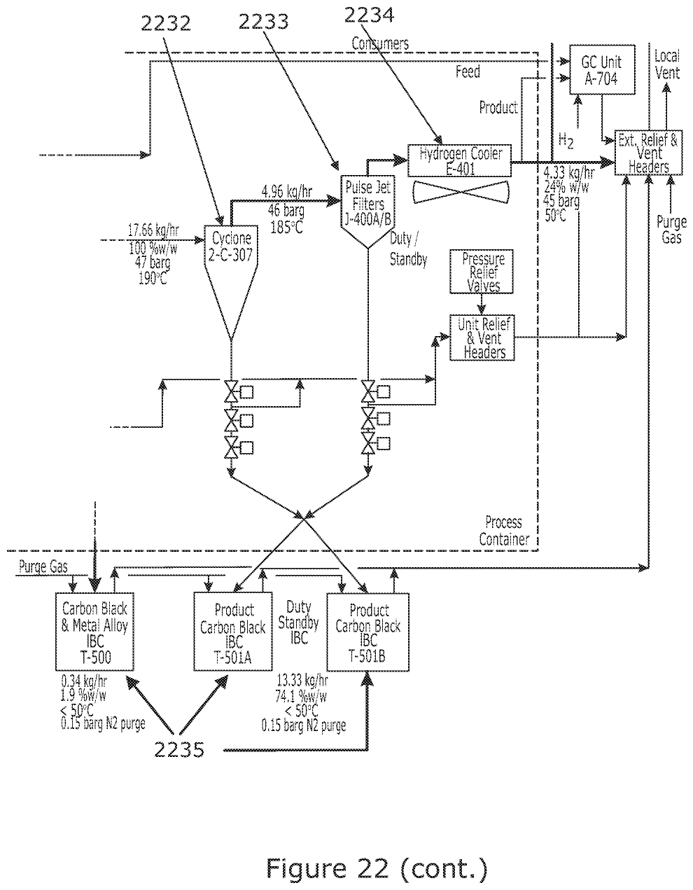

Hyperbaric operation of the plasma torch is common to embodiments of the invention described here, and the reaction system is typically contained within a pressure vessel as shown in FIG. 1. However, an effective reaction can be achieved at a variety of pressure regimes—while the system described here is particularly suitable for operation at 50 barg (50 bars above atmospheric pressure), it is differentiated from conventional approaches to use of plasma torches in connection with pyrolysis by hyperbaric operation and use of a system at lower but still elevated pressures (20 barg, 10 barg, or even 1 barg) allows for more efficient operation than in temperatures operating at atmospheric pressure. As will be noted further below, operation at lower temperatures and with lower power torch operation is also possible (this is discussed further below with respect to FIG. 22).

FIGS. 7 to 10 illustrate the system for mounting the plasma torch and for providing gaseous feedstock and electrical power to the plasma torch in embodiments of the invention.

One potential issue with a reactor design of this type is that if there is a need to maintain a plasma torch, then the reactor could lose significant efficiency because of the long cycle time that taking a plasma torch out of commission would require. This is because the torch would need to be brought down to a much lower temperature and pressure for maintenance, and it then would need to be brought back up to temperature and pressure to operate again. In embodiments of the invention, the approach taken is to use multiple torches for each “torch position” in a reactor, wherein one of the plasma torches is in an active position and ready for operation, with other plasma torches in other positions where they can be made ready for removal or for operation without affecting the torch that is actually in operation. This approach can be combined effectively with an efficient system for providing electrical power and gaseous feedstocks to the plasma torch.

FIG. 7 shows one embodiment of this multiple torch approach—in this embodiment, three torches 71, 72, 73 are mounted in a carousel or revolver 70. The revolver 70 can rotate about a longitudinal axis, but after rotation is locked in one of three positions with one of the three torches in an active position, or active bay, where it is operative within the reactor. A feedthrough system 74 is provided along the axis of the revolver 70, and this system is configured such that gaseous feedstocks and electrical power are provided to the plasma torch which is in the active position. The other two plasma torches are not in the active position, and they can be made ready for use or for extraction—for example, one of the two positions could be a “ready” position (or loading bay) in which a torch is brought up to working temperature, and the other of the two positions could be a “cool-down” position (or cooling bay) in which a previously active torch could be cooled down and depressurised ready for removal for maintenance.

FIG. 8 shows a plasma torch fitting into a torch position in the revolver. The three torch positions are arranged symmetrically around the axis of the revolver, and the plasma torch slides in from the side remote from the reactor until it is locked in position and provided with appropriate pressure sealing such that when it is rotated into the active bay, the pressure within the plasma torch chamber can be maintained.

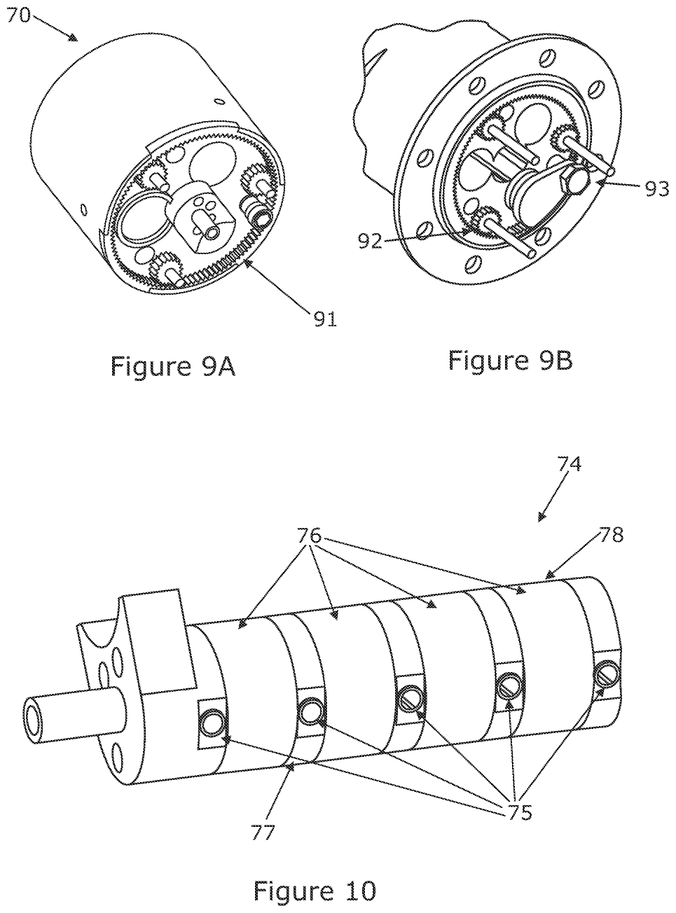

FIGS. 9A and 9B shows a gear system 91 by which the bays of the revolver may be rotated between the three available positions—any appropriate gear system may be used. A locking mechanism is provided so that the bays may only be locked into the designated positions—with three bays, this would involve three possible locking positions. FIG. 9B indicates two ways in which this may be done. The pin 93 on the revolver cap penetrates the revolver core and can be used to lock the revolver into position. Alternatively, one of the gears—for example, the gear 92 at the stepper motor connection—may be locked into place with the motor control (if desired, each of the gear shafts can be locked in this way).

FIG. 10 shows a feedthrough system for use with the revolver shown in FIGS. 7 to 9. A feedthrough system 74 is provided for each revolver and provides electrical and gaseous inputs to the torch in the active bay—inputs could also be provided to other bays (for example, cooling gas to the cooling bay) if required, but generally the feedthrough system will be formed so as to have inputs only to the active bay for use by the torch in the working position. In contrast to the torches, the feedthrough system will adopt a fixed configuration with respect to the bays, so that the correct inputs are provided to the active bay regardless of which torch is disposed in the active bay at any given time. Using this approach, specific input locations can be designated for specific input gases. In some cases, this may be generally independent of the reaction in the plasma torch (for example, lower temperature hydrogen may be input to cool the anode in a number of different reactions) but in other cases specific gaseous inputs may be provided to enter the plasma torch at particular positions 75 for particular reactions—multiple gas inputs 37 in the plasma torch (see FIG. 3) may commute with these supply outputs 75. The feedthrough system can in this way be coded (for example, colour coded) for particular feedstock gases and particular reactions. In FIG. 10, the gaseous inputs are shown, but electrical connections are not. Ceramic insulators 76 are however shown to separate connections, in particular electrical connections, on the torch. As for the torch, this arrangement needs to be provided with pressure seals effective to allow a pressure of 50 bars to be maintained within the plasma torch chamber in use. Different approaches to the construction of an appropriate feedstock system can be taken, but the approach shown here uses a series of aligned disks—in this case these are metal disks 77 separated by ceramic insulating disks 78.

While the feedstock system is described above in relation only to inputs, it may also be used for outputs. For example, where there is recirculation (as for example with hydrogen, which is produced as an output but also used as a cooling gas), the recirculation system may use both inputs and outputs through the feedstock system.

It should be noted here that different torches could in fact be used for different reactions—for example, a torch may be designed with feedstock input positions optimised for methane, and another torch with different input positions optimised for a different feedstock gas. These different input positions may be aligned with different positions on the feedstock system in such a way that only the correct input gas and torch combinations can be used. It may also be possible to reconfigure the feedstock system so that the same feedstock gas can be supplied to different positions for different torches (or even different reactions)—this could be achieved with addition of valves in the feedstock system with a preconfigured set of valve positions for particular arrangements.

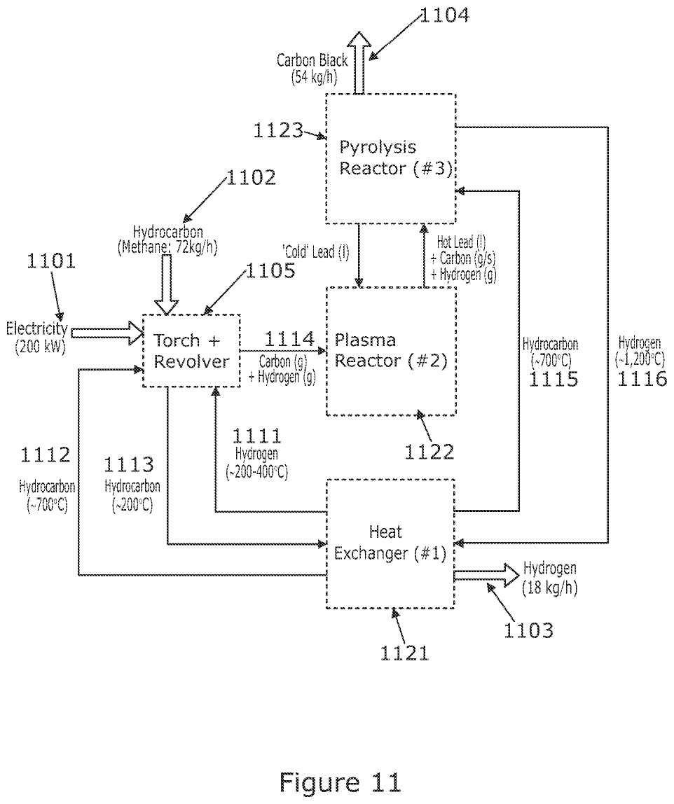

Before describing the other elements of the reactor, an overall reaction flow will be described with respect to FIG. 11. This reaction flow is specific to decomposition and pyrolysis of methane, but it is used here more generally to illustrate the different reaction processes taking place in different parts of the composite reactor. For example, other hydrocarbons such as propane may be used as a feedstock hydrocarbon, rather than methane, in not only the plasma torch reactor but also the liquid metal reactor.

Two inputs to the system are shown: electricity 1101 and hydrocarbon 1102 (in this case, methane). Two outputs are shown: hydrogen 1103 (though for other reactions, other output gases may be provided as well or instead—note also that some of the hydrogen generated is recirculated for use in the reaction processes) and carbon black 1104.

Both inputs are provided to the plasma torch 1105—in addition to electrical power and the hydrocarbon feedstock, hydrogen is provided as an input. In the arrangement shown, a low temperature hydrogen input 1111 (shown here in the 200-400 degree Centigrade range) is provided to the plasma torch 1105 for cooling the anode, for example, with high temperature hydrocarbon 1112 (shown here at around 700 degrees Centigrade), used as a reaction feedstock and also to maintain the temperature and pressure of the reaction chamber and to promote the flow of material through the plasma torch. As the plasma torch consumes electrical energy and generates a high temperature output, this is partially consumed by the pyrolysis reaction in a second reactor 1122, from which heated output gases can be used in a heat exchanger 1121 to circulate the hydrocarbon feedstock so that it is elevated from low temperature hydrocarbon 1113 at about 200 degrees Centigrade to high temperature hydrocarbon 1112 at a plasma torch reaction temperature of about 700 degrees Centigrade—the heat exchanger 1121 can also provide hydrogen at cooler temperatures to the plasma torch. This heat exchanger 1121 thus effectively acts as a first reactor process, absorbing the heat of the end process and using it to bring gases required for reaction stages to the correct temperature.

The plasma torch 1105 itself acts as a second reactor 1122, providing high temperature hydrogen and (primarily) gasified carbon as outputs 1114. The plasma torch 1105 through its reaction products operates on the next reactor stage, which is a liquid metal pyrolysis reactor 1123. The plasma torch 1105 provides heat for this reaction, heating up the metal (here, lead) to reaction temperature, and also providing rotation to the lead, allowing the carbon to be extracted at the centre of the reactor. More high temperature hydrocarbon 1115 is provided from the heat exchanger 1121 as a feedstock for the liquid metal pyrolysis reactor 1123. The hydrogen output 1116, provided at very high temperature (approximately 1200 degrees Centigrade) from the exothermic reaction in the pyrolysis reactor, is returned to the heat exchanger 1121 and partly recirculated to the plasma torch 1105 while mainly provided (at a lower temperature) at the hydrogen gas output 1104.

The liquid metal pyrolysis reactor is shown in more detail in FIGS. 12 to 18. FIG. 12 illustrates the main elements of the reactor assembly. The torch mounting 121 is directed into a liquid metal racetrack 122 which feeds into the main reactor volume 123. There are also gas inputs 124 to the main reactor volume 123, which contains a swirl chamber 125. The liquid (molten) metal is delivered into the swirl chamber 125 so as to give rotation to the liquid metal column, allowing the liquid metal both to initiate a pyrolysis reaction in the input gas and to act as a centrifugal separator, separating reaction products towards the centre of the rotating column. Carbon is then extractable from the base of the reactor in a carbon output 126. Hydrogen rises from the liquid metal and is released through a hydrogen output 127 from the top of the reactor. The reaction is carried out at elevated temperature and pressure (typically 800-1000 degrees Centigrade and 50 bar).

This functionality may be usefully combined with that of the plasma torch even if the liquid metal system is not itself a reactor—in that case, it only acts as a separator to separate the reaction products from the plasma torch, powered by the energy of the plasma torch output. This leaves significant excess heat, however, and it is found that making the liquid metal system itself a reactor, used for endothermic pyrolysis of further hydrocarbon, leads to a particularly effective reactor system.

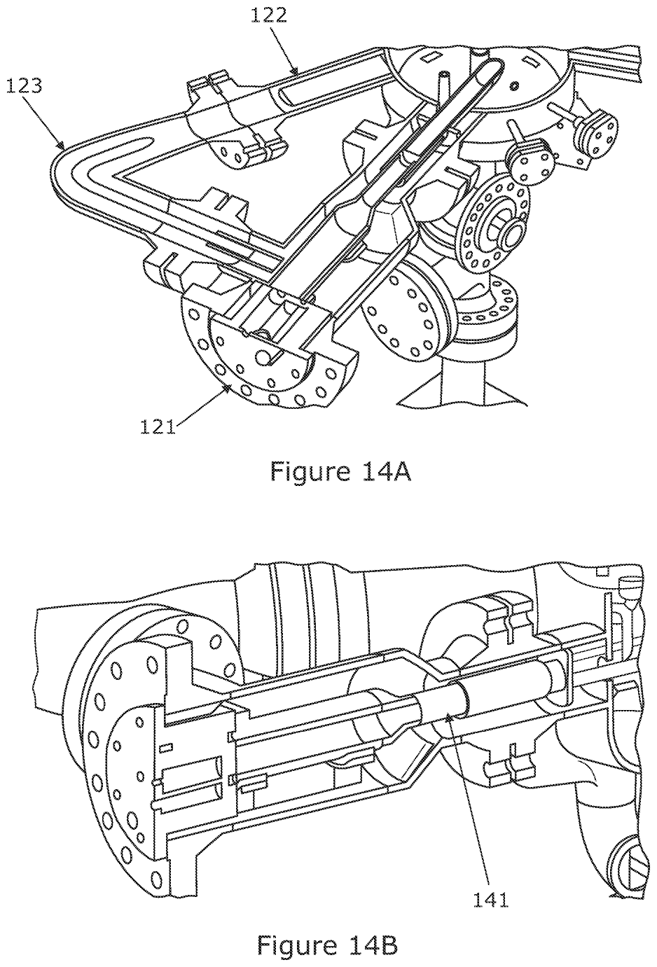

FIGS. 13A and 13B show the plasma torch mounting and the liquid metal racetrack from different angles, and FIGS. 14A and 14B show different sectional views of these elements. Liquid metal passes out of the reaction chamber as it cools and reaction products are separated, and it then passes through a liquid metal racetrack 122 past an elbow joint 128 towards the plasma torch mounting 121, where the plasma torch output is jetted into the liquid metal. This heats the liquid metal up to a sufficient temperature to initiate a pyrolysis reaction in hydrocarbons such as methane, and also carries the reaction products of the plasma torch reaction into the liquid metal reactor so that they can be collected from the system (methane passing into the liquid metal from the plasma torch jet may also be pyrolyzed at this point). The heated metal passes along the rest of the liquid metal racetrack and enters the liquid metal reactor chamber from the bottom. The parts of the racetrack structure as a result need to withstand high temperatures from the heated liquid metal, and they will also need to be adapted for expansion from the significant difference between temperatures during reaction processes and outside reaction processes. Joints may for example be protected by use of molybdenum sleeves 141, as shown in FIG. 14B.

The plasma torch is designed so that it will jet effectively into the liquid metal racetrack 122—in particular, the diffuser of the plasma torch is designed to match pressures with the outside of the torch. This will have the benefit of supporting linear rather than turbulent flow in the liquid metal racetrack. The liquid metal may be brought into a swirl or vortex which will act to stabilize the plasma jet. Reaction products from the plasma torch—in the example shown, hydrogen and carbon—will be carried in the liquid metal for subsequent separation in and output from the liquid metal reactor, as described below.

The liquid metal system may also serve to purge the outputs of the plasma torch reactor from impurities. For example, ethylene may be produced as a byproduct but then be broken down again in the liquid metal system.

The liquid metal from the liquid metal system may have other functions. For example, the diffuser of the plasma torch may extend sufficiently far into the liquid metal racetrack that the liquid metal will act to clean the diffuser and prevent carbon build-up there—in embodiments, the diffuser section may be porous in part to support liquid metal flow. If desired, the liquid metal from the racetrack could even be driven up to flood the plasma torches, rapidly quenching the reaction and stopping their operation. Liquid metal could thus be used to flood—and hence clean—the porous anode (and where used, cathode) structures.

This has consequences for the operation of the system on shutdown and startup. Once the plasma torch is stopped, some degree of backfilling of the plasma torch structure from the liquid metal racetrack can be expected—liquid metal will enter the torch chamber, and (depending on the choice of metal) may solidify as the torch cools. If porous electrodes are used, the electrodes, or at least the electrode closest to the torch aperture may flood with liquid metal. This can be used beneficially for effective operation of the torch, and for extending its working lifetime. The electrodes may be directly replenished by the solidified metal, which may compensate for erosion during use. Restarting a plasma torch is normally achieved using a high voltage pulse—this will typically have a significant ageing effect on the electrodes and on the torch structure generally. If liquid metal has entered the torch chamber, and particularly if it has formed a solid metal plug, the effect of starting the torch is significantly softened. Such a solid metal plug will typically form a link between the electrodes of the plasma torch, so the high voltage pulse will typically result in a high current (perhaps 200 A) through the plug which will heat and melt it very rapidly—the combination of plug melting with the supply of feedstock gas to the torch will result in rapid expulsion of the metal plug while also providing a soft start to the plasma torch to reduce the ageing effect of power cycling it—the result is a more effective autoignition process assisted by the liquid metal system. To make expulsion of the plug more rapid, this may be stimulated either by injection of gas behind the plug or vacuum in advance of it to pressure the plug forward into the liquid metal system. A mechanical system for engaging with and ejecting the plug is also possible.

Lead, or a mixture containing lead, may be used as the liquid metal in the liquid metal system. Lead is a suitable choice as it is liquid at reaction temperatures without having a high vapour pressure, and it creates fewer toxicity issues than most other suitable metals. Gallium is another possible choice, as is bismuth. One alloy used in embodiments of the system is WR58, comprising bismuth and lead, available from William Rowland Ltd. While the term “liquid metal” is used throughout this description, in embodiments the circulating liquid may not itself be a metal, providing that it is a liquid at reactor temperatures and supports separation of the reaction products (and where acting as a reactor, supports further pyrolysis) but does not itself have a further chemical reaction with feedstock gases or pyrolysis reaction products. A number of salts also have appropriate properties. As noted above, where a cooled plug is used for autoignition of the torch it will be necessary for the circulating liquid to become solid when the reactor is cold and for it to be electrically conductive to some degree.

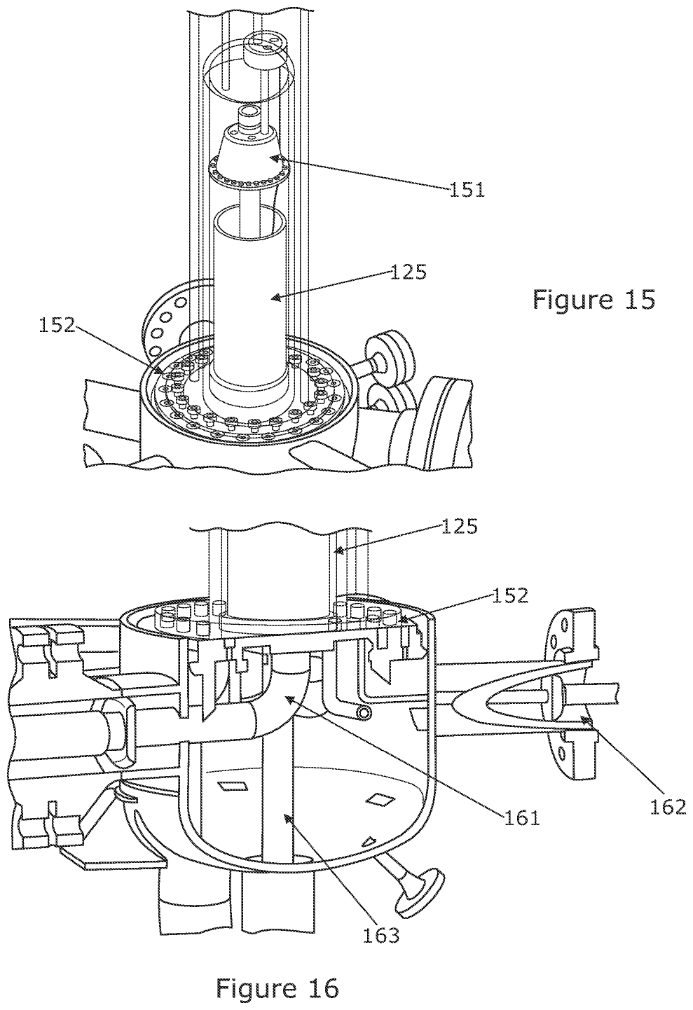

As noted above, the liquid metal system is here designed to act not only as a separator but also as a reactor. FIG. 15 provides a view of the swirl chamber 125 which forms the reaction chamber for the liquid metal pyrolysis reactor. Heated liquid metal is passed into this chamber from below along with input gases, and circulation within the swirl chamber 125 leads to separation with the reaction products separated by centrifugal action into the centre of a circulating liquid metal column, with carbon and hydrogen initially collected in a hat structure 151 at the top of the reactor. This can be used to collect clean hydrogen—this will be the only gas at this point and can simply be released through a float valve. A liquid salt structure can be provided in this structure for the lead and carbon mixture to percolate through—this will separate out the carbon from the lead, with the process being completed by gravity with the lighter carbon floating up over both the lead and the salt, which are heavier. This enables the carbon to be separated by dropping it through a chute in the central region of the chamber. The base plate 152 beneath the swirl chamber 125 has through holes for gaseous inputs. Cooling metal passes out through holes in the side of the swirl chamber 125 and down through the base plate 152 where it circulates on to the liquid metal race track shown in FIGS. 13 and 14.

Further details of the swirl chamber 125 are shown in FIGS. 16 to 18.

FIG. 16 shows the lower part of the liquid metal reactor vessel, beneath the swirl chamber 125 in which the reaction takes place. Hot metal heated from the plasma torch enters from below through metal inlet 161 with reaction gases entering through gas inlets 162. Carbon is output through the bottom of the reactor in carbon output 163. Hydrogen is circulated down through the base plate 152 of the swirl chamber 125 for subsequent circulation and collection above the swirl chamber.

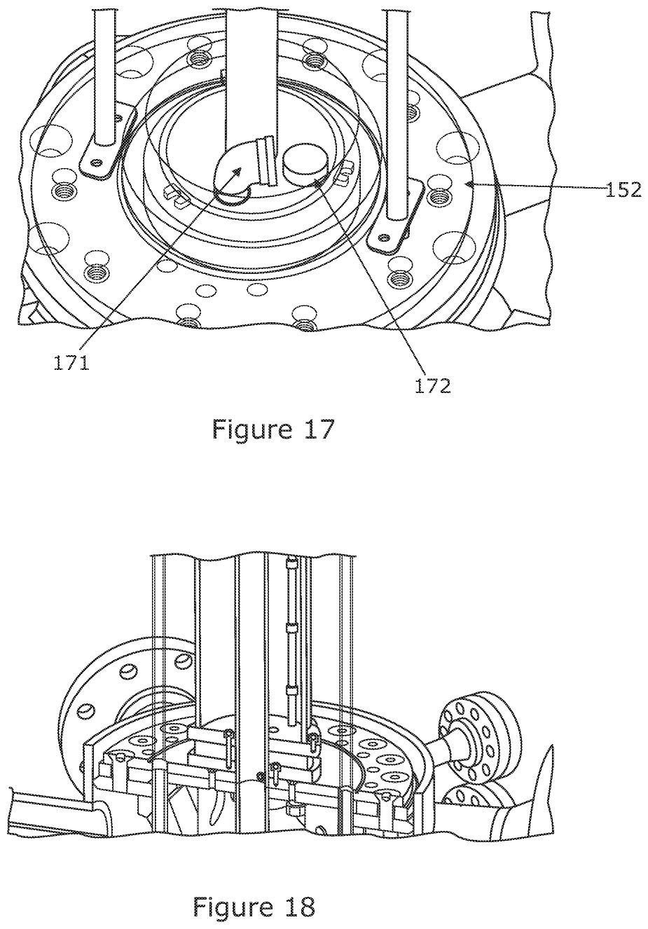

FIG. 17 shows the region above the base plate 152 of the swirl chamber 125. The liquid metal is input through an elbow 171 tangentially to the liquid metal column—this provides the liquid metal column with rotation so that it acts as a centrifugal separator. Also shown in FIG. 17 is a percolation inlet 172 for further feedstock gas—in this case, methane for pyrolysis. The percolation inlet 172 is here disposed directly in front of the incoming liquid metal from the elbow 171 so that the further feedstock gas percolates directly into the liquid metal flow for pyrolysis. This process can be further developed by use of appropriate catalysis—for example, nickel balls (not shown here) can be included in the swirl chamber 125—these will elongate the flow path of the injected methane, promoting reaction, while also cleaning the hydrogen of impurities. Nickel balls are an attractive choice as they would float on lead (if used as liquid metal) but sink in the salt, and so would be effectively confined to the separation layer. The connections through the base plate 152 are shown in more detail in the sectional view of FIG. 18.

As has been described above, a heat exchanger system is provided which allows the heat generated in reaction to be used to provide input gases at the correct temperature for use in the reaction. The hydrogen output from the liquid metal reactor, which is at high temperature (1200 degrees Centigrade) is used to heat up methane feedstock for provision to both the plasma torch and to the liquid metal pyrolysis reactor. A part of this hydrogen output is cooled to a much lower temperature (for example 200 to 400 degrees Centigrade) and used to cool the anode and the cathode of the plasma torch, as described above.

While the reactor embodiment described here is adapted for pyrolysis of methane, this reactor structure can be employed for a number of reactions. As noted in the discussion of the feedstock system, for example, a variety of input gases may be used in different reactions, with input positions of gases chosen to achieve the correct circulation of gases throughout the plasma torch. Similarly, different inputs may be provided to the liquid metal reactor, rather than simply methane, to achieve different reactions.

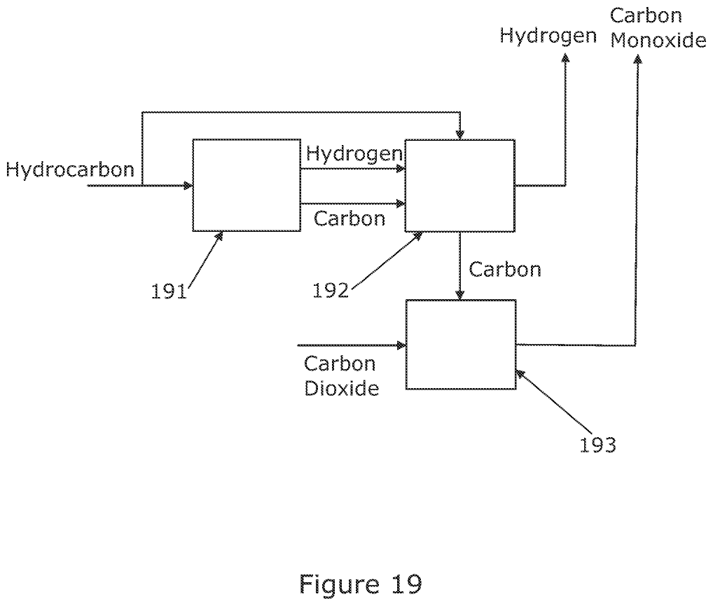

While the reactor processes described in the example above are directed to production of hydrogen and carbon from methane, the reactor structure used here can be adapted for other reaction processes. As shown in FIG. 19, after methane or another hydrocarbon has been broken down 191 into hydrogen and carbon—either directly in the plasma torch or through subsequent pyrolysis in the liquid metal reactor, and separation 192 has taken place in the liquid metal separator, syngas (syngas, or synthesis gas, is primarily a mixture of hydrogen and carbon monoxide) may be produced 193 by addition of carbon dioxide to the carbon stream as a further input gas. The carbon dioxide is reduced by the carbon to form carbon monoxide, which can be collected with hydrogen above the swirl chamber and extracted as syngas. Using this approach, the carbon monoxide will be released outside the swirl chamber and will percolate up for collection at the top of the vessel. There may then be outputs of both hydrogen (from the hat over the swirl chamber) and of syngas (from the top of the whole liquid metal reactor structure).

In the approach generally described above, heat from the plasma torch is used by an endothermic reaction—methane pyrolysis in the main example—to establish an efficient composite reactor. While this is an effective use of the heat provided by the plasma torch, if there is an alternative way to use this heat, then the liquid metal system need not be used as a reactor. In other embodiments, for example, the liquid metal system may be used essentially for separation of hydrogen and carbon generated by the plasma torch reactor, in which case no feed of methane to the liquid metal system is required.

While much of the heat from the plasma torch reactor is used by the endothermic methane pyrolysis reaction, a significant proportion of the heat is removed from the reactor with the hydrogen output, which is provided at elevated temperature (typically 1200 degrees Centigrade). In the arrangement shown here, this is used to bring feedstock gases—methane for the plasma torch, and also for the liquid metal reactor—up to reaction temperature in a conventional heat exchanger. As is described above, it is desirable for a further output from the heat exchanger to be a lower temperature stream of hydrogen for cooling of electrodes. However, if there is an effective alternative use of this output heat, this heat exchanger need not be used—other approaches may be taken to bring gases up to appropriate reaction temperatures, and a source of hydrogen at ambient or another sub-reaction temperature may be used.

FIG. 22 is a system diagram of a reactor system according to a further embodiment of the invention. In this design, the temperature of operation is lower, the liquid metal system conveys product away from the torch for separation rather than providing an additional reactor stage, and the heat exchanger stage is not used. While this reactor system is designed for lower temperature operation (here for 250° C. normal temperature with an operating range of 200-300° C. through the reactor as a whole—though clearly the temperature locally at the plasma spark will be significantly higher) it is also designed for high pressure operation (with 50 barg as the normal reactor pressure, with an operating range of 40-60 barg). In this arrangement, a hydrocarbon feed 2202—methane, for preference—is provided at ambient temperature and pre-heated to 80° C. before being provided to the plasma torch 2205. In this embodiment, a single plasma torch is used (there is no revolver). The system is designed for 18 kg/hr throughput with the whole system operating at around 50 barg. The plasma torch 2205 operates at 50 KW (up to 800 VDC, 300 Amps). The reaction products of hydrogen and carbon black are jetted out into the liquid metal handling system (which may also be termed a quench reactor—this is equivalent to the “plasma reactor” of the FIG. 11 arrangement)—in this case, the liquid metal system uses WR58 alloy heated to at least 80° C., with the liquid metal system 2214 supplied from a metal supply tank 2214a. The reaction products are extracted from the liquid metal handling system 2214 by an extraction system 2230 here comprising a first and a second cyclone 2231, 2232 and a pulse jet filter 2233 (with an alternate pulse jet filter than can be switched in). Each of these systems deposit carbon black as a solid while allowing a gas comprising predominantly hydrogen to progress to the next stage. In the arrangement shown, the first cyclone 2231 accepts a stream from the reactor at 18 kg/hr, 48 barg and 200° C.). The solid deposited by the first cyclone 2231 will be carbon black with some metal alloy, so a separator is needed at this point. The second cyclone 2232 accepts an input at 17.66 kg/hr, 47 barg, 190° C., and outputs gas at 4.96 kg/hr, 46 barg and 185° C. while shedding more carbon black. This output is received by the pulse jet filter 2233, which sheds more carbon black and outputs hydrogen gas, which is cooled to ambient temperature in a cooler 2234. The carbon black will be deposited into intermediate bulk containers 2235—the arrangement shown optimises deposition into the second and third bulk containers such that most of the carbon black produced does not require separation from the liquid metal.

Further embodiments can be produced with higher operating temperatures up to the high temperature operation (which may be at 1200° C.) of the FIG. 11 arrangement. Such designs may use features from either or both of the FIG. 11 and FIG. 22 arrangements, as appropriate—for example, an intermediate design may have a heat exchanger similar to that shown in FIG. 11 while using a separation arrangement of the type shown in FIG. 22.

As the skilled person will appreciate, other embodiments of the plasma torch and the reactor technology and reaction processes set out here may be provided within the scope of the claims provided, without limitation to specific features set out in the embodiments but not required by the claims.

1. A plasma torch for use in a chemical reactor, the plasma torch comprising:
a torch chamber with an open end for outflow of reaction products and a closed end opposite to the open end;
a first electrode disposed in the torch chamber;
a second electrode disposed in the torch chamber between the first electrode and the open end;
an input system for input of one or more gaseous feedstocks into the plasma torch;
wherein the plasma torch is adapted to operate at substantially above atmospheric pressure and wherein the plasma torch is configured so that flow of gaseous feedstocks and reaction products through the torch is adapted to prevent or reduce solid deposition on the second electrode.

2. The plasma torch of claim 1, wherein at least the second electrode is substantially cylindrical, and wherein the second electrode has a circular cross section, but wherein the cross-sectional diameter varies along the length of the second electrode.

3. (canceled)

4. The plasma torch of claim 2, wherein the second electrode comprises a Venturi nozzle and a diffuser section at the open end to collimate an outflow of reaction products.

5. The plasma torch of claim 1, wherein the closed end is formed by a ceramic cup.

6. The plasma torch of claim 1, wherein a section of the torch chamber comprising one or more gas inputs from the input system has a generally circular cross-section, and wherein the one or more gas inputs are directed tangentially to the circular cross-section of the torch chamber.

7. The plasma torch of claim 6, wherein the one or more gas inputs are disposed in a ring element of which an inner surface forms a part of a wall of the torch chamber.

8. The plasma torch of claim 7, wherein there are a plurality of gas inputs in the ring element, the gas inputs being disposed symmetrically around the inner surface of the ring element.

9. The plasma torch of claim 6, wherein the torch chamber is shaped to support a helical flow of gases through the torch chamber.

10. The plasma torch of claim 9, wherein the helical flow of gas through the torch chamber comprises a larger diameter helix from the gas inlet or inlets to the closed end of the torch chamber, and a smaller diameter helix from the closed end of the torch chamber to the open end of the torch chamber.

11. (canceled)

12. (canceled)

13. The plasma torch of claim 1, wherein either or both of the first and second electrodes is porous, and wherein each such porous electrode is connected to a gas input to allow gas to flow through the electrode.

14. The plasma torch of claim 13, wherein the passage of gas through the electrode has a component either towards or away from the open end of the torch chamber.

15. The plasma torch of claim 1, wherein the plasma torch is adapted to operate at an internal pressure of greater than 10 barg, preferably at greater than 30 barg, and more preferably in the range of 40 to 60 barg.

16. The plasma torch of claim 1, wherein the plasma torch is adapted for the gaseous feedstock to comprise at least one hydrocarbon and for the reaction products to comprise hydrogen.

17. The plasma torch of claim 16, wherein the solid deposition is deposition of carbon.

18. (canceled)

19. The plasma torch of claim 1, wherein the plasma torch is adapted to jet into a non-reactive liquid.

20. (canceled)

21. (canceled)

22. A method of operating a plasma torch in a chemical reactor, the plasma torch comprising a torch chamber with an open end for outflow of reaction products and a closed end opposite to the open end, with a first electrode disposed in the torch chamber and a second electrode disposed in the torch chamber between the cathode and the open end, the plasma torch further comprising an input system for input of feedstock gases into the plasma torch, the method comprising:
flowing one or more feedstock gases into the torch chamber through the input system;
consuming one or more feedstock gases in the plasma torch to form one or more reaction products; and
operating a flow of feedstock gases and reaction products through the plasma torch so as to prevent or reduce solid deposition on the second electrode, wherein the pressure in the plasma torch is substantially above atmospheric pressure.

23. The method of claim 22, wherein solid deposition is reduced by accelerating flow through the second electrode by use of a Venturi nozzle.

24. The method of claim 22, wherein a wall of the torch chamber is substantially circular in cross-section where feedstock gases are injected into the torch chamber, and where solid deposition is reduced by injecting feedstock gases into the torch chamber tangentially to the circular cross-section of the torch chamber wall such that the feedstock gases adopt a helical path through the torch chamber.

25. The method of claim 24, wherein the helical path comprises a larger diameter helix from the input of gases into the torch chamber to the closed end of the chamber, and a smaller diameter helix from the closed end of the chamber to the open end of the chamber, thereby keeping a flow of reaction products away from the wall of the torch chamber.

26. The method of claim 25, wherein the first electrode and the second electrode are configured such that a spark gap therebetween is adapted to pass primarily through the smaller diameter helix.

27. The method of claim 22, wherein the first electrode and the second electrode are disposed such that sparking between the first electrode and the second electrode is adapted to erode any solid deposition on the second electrode.

28. The method of claim 22, wherein one or both of the first electrode and the second electrode is porous, and further comprising flowing input gas through each such porous electrode, and over a surface of each such porous electrode, such that the surface of each such electrode is protected from solid deposition.

29. The method of claim 28, wherein flowing input gas through each such porous electrode erodes solid deposition by a reaction with deposited solid material.

30. The method of claim 28, wherein the input gas flowing through the or each porous electrode has a component of flow either towards or away from the open end of the torch chamber.

31. The method of claim 28, wherein the input gas flowing through the or each porous electrode is substantially cooler than the feedstock gas or reaction products, and the input gas is adapted to cool the porous electrode.

32. The method of claim 22, wherein an internal pressure in the plasma torch in operation is greater than 10 barg, preferably greater than 30 barg, and more preferably in the range of 40 to 60 barg.

33. The method of claim 22, wherein a flow of reaction products out of the plasma torch is directed as a jet into a stream of non-reactive liquid.

34. The method of claim 33, wherein when the plasma torch is turned off, non-reactive liquid enters and partially fills the plasma torch chamber.

35. (canceled)

36. The method of claim 33, wherein the non-reactive liquid comprises a liquid metal, liquid metal alloy, or liquid salt.

37. The method of claim 33, wherein the non-reactive liquid is a liquid at a reaction temperature and a solid at ambient temperature.

38. The method of claim 22, wherein the feedstock gases comprise a hydrocarbon, optionally methane.

39. The method of claim 38, wherein one or both of the first electrode and the second electrode is porous, and further comprising flowing input gas through each such porous electrode, and over a surface of each such porous electrode, such that the surface of each such electrode is protected from solid deposition, and wherein the feedstock gases further comprise hydrogen, and said hydrogen is used as the input gas for the porous electrode or electrodes.
